(19) United States
(12) Patent Application Publication
(10) Pub. No.: US 2009/0177511 A1
(43) Pub. Date: Jul. 9, 2009

(54) RECRUITING AND APPLICANT QUALIFICATION SYSTEM

(76) Inventors: Matthew Mark Shaw, Chesterfield Township, MI (US); Amit Singh Dang, West Bloomfield Township, MI (US)

Correspondence Address: HARNESS, DICKEY & PIERCE, P.L.C., P.O. BOX 828, BLOOMFIELD HILLS, MI, 48303, US

(21) Appl. No.: 12/350,893

(22) Filed: Jan. 8, 2009

Related U.S. Application Data
(60) Provisional application No. 61/019,661, filed on Jan. 8, 2008.

(51) Int. Cl. G06Q 10/00; G06Q 50/00

(52) U.S. Cl. 705/7

(57) ABSTRACT

A recruiting system comprises a server that stores applicant guidelines, an administration module that updates the applicant guidelines in the server, and a recruiting module. The recruiting module receives characteristics of an applicant, and the characteristics are compared to the applicant guidelines. The recruiting module displays a recruiting disposition for the applicant. The characteristics are stored when the applicant is unqualified, and the characteristics are compared to applicant guidelines after the administration module updates the applicant guidelines.

### CROSS-REFERENCE TO RELATED APPLICATIONS

This application claims the benefit of U.S. Provisional Application No. 61/019,661, filed on Jan. 8, 2008. The disclosure of the above application is incorporated herein by reference in its entirety.

### FIELD

The present disclosure relates to recruiting systems, and more particularly to systems used for gathering and assessing qualifications of applicants.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Current standards-based recruiting systems may be less than optimal in various respects. For example, consider the United States Army Recruiting Command (USAREC), which uses a complex system for creating and disseminating eligibility criteria to its recruiting staff. Referring now to FIG. 1A, a flowchart depicts steps performed in the current USAREC recruiting process. The Army prints a manual that covers enlistment and is titled Army Regulation (AR) 601-210, Personal Procurement Active and Reserve Component Enlistment Program. This is a paper manual that is printed and issued to each recruiter, in step 106, during recruiter school, known as the Army Recruiter Course (ARC).

AR 601-210 includes standards used by USAREC to determine if an applicant is eligible to join the Army, either as an enlisted soldier or as an officer or a warrant officer. AR 601-210 states the minimum (or maximum, as appropriate) standards for categories of enlistment eligibility. The standards covered by AR 601-210 include, among others, moral requirements (such as criminal background), medical requirements, age limits, education level requirements, maximum number of dependants, marital status restrictions, citizenship requirements, and enlistment pay grades upon entry. AR 601-210 also references standards contained in other manuals.

Currently, in order to determine if an applicant is eligible to join the Army, the recruiter must rely on his/her understanding of AR 601-210, reference AR 601-210 by hand, or seek assistance from a more experienced recruiter. This process can be cumbersome because the chapters are not necessarily organized in a quickly accessible manner. In addition, the standards for each type of applicant vary greatly. For example, an applicant who has served in the Army or another branch of the military will be subject to different standards than an applicant who has never served in the military.

To further complicate analysis, an applicant who previously joined the military but never began training falls into another category, while an applicant who began but never completed training falls into yet another category. Each of these categories has different requirements, and may be influenced by other criteria. For example, the Army may determine that an applicant with one education level may have more criminal convictions than an applicant with a lower education level.

Recruiting goals for the Army are determined in step 102. For example only, recruiting goals may include a desired number of recruits in each of various categories. In addition, recruiting goals may include a desired total number of recruits. In the next step, step 104, the enlistment criteria are determined based upon the recruiting goals. In the next step, step 106, the Army assembles and distributes the manual of enlistment standards and criteria to the recruiters during recruiting school, as described above.

In the next step, step 108, headquarters determines current recruiting needs and the availability of qualified applicants, which may both change over time. In order to match the recruiting volume requirements with the necessary candidates enlistment requirements, in step 110, the Army may modify the enlistment criteria. The Army therefore alters the criteria in AR 601-210 on a regular basis. When USAREC or the Army decides to change the enlistment criteria, they describe the changes in text form. These changes are emailed to Army recruiters across the globe in step 112. These changes are also posted on a website, in the order in which they were issued, for future reference. Control then returns to step 108, where headquarters will once again evaluate recruiting needs.

Referring now to FIG. 1B, a flowchart depicts steps performed by a recruiter in the current Army recruiting process. In step 140, the recruiter receives a manual in recruiting school. Updates to the recruiting enlistment standards may already exist, and so the recruiter then updates the manual with these changes. Further updates may be released while the recruiter is still in recruiting school, requiring further revision of the manual.

In step 142, the recruiter qualifies applicants based on the manual, as updated. In step 144, the recruiter receives emails containing changes to AR 601-210. The recruiter prints out the email, identifies the section of AR 601-210 to which it pertains, and updates the manual in step 146. Updating may involve physically crossing out, writing over, and/or inserting the paper copy of the email into the manual (such as by stapling, gluing, or some other method of affixing the new document). Control then returns to step 142, where the recruiter qualifies new applicants based on the updated manual.

After a few months, the recruiter's manual may be messy or inaccurate. If the recruiter cannot recall a specific manual change, the website is available for reference. However, updates are available on the website only by the date they were posted, and not categorized in any way. A specific criteria change can only be found by repeatedly guessing on which date the change was issued until it is found.

Further, the recruiter must determine a disposition—a decision on an applicant's eligibility—based on disparate information throughout AR 601-210. The dispositions include qualified, disqualified, and permanently disqualified. An applicant whose disposition is ‘disqualified’ may require further review of the specific circumstances related to certain eligibility requirements.

Certain procedures and documents may be necessary for each type of applicant situation, such as second level evaluations and approvals, known as waivers or reviews. Further, it may be possible for elements of one chapter of AR 601-210 to override elements of another chapter. In addition, AR 601-210 may specify that requirements are to be met without providing specific standards for those requirements, such as height and weight limits, which are detailed in a separate regulation.

### SUMMARY

A recruiting system comprises a server that stores applicant guidelines, an administration module that updates the applicant guidelines in the server, and a recruiting module. The recruiting module receives characteristics of an applicant, and the characteristics are compared to the applicant guidelines. The recruiting module displays a recruiting disposition for the applicant. The characteristics are stored when the applicant is unqualified, and the characteristics are compared to applicant guidelines after the administration module updates the applicant guidelines.

In still other features, the systems and methods described above are implemented by a computer program executed by one or more processors, servers, or other devices. The computer program can reside on a computer readable medium such as but not limited to memory, non-volatile data storage, and/or other suitable tangible storage mediums.

A recruiting system includes a server, an administration module, and an interface module. The server stores applicant guidelines. The applicant guidelines include physiological and educational guidelines. The administration module selectively updates the applicant guidelines in the server. The interface module receives characteristics of an applicant. The applicant characteristics include physiological and educational characteristics. The applicant characteristics are compared to the applicant guidelines to generate a recruiting disposition for the applicant. The applicant characteristics are stored when the recruiting disposition is other than a qualified disposition. The comparison between the applicant characteristics and the applicant guidelines is repeated to generate a new recruiting disposition when the administration module updates the applicant guidelines.

In other features, the applicant guidelines include standards for military enlistment. The interface module displays the recruiting disposition. The interface module displays the new recruiting disposition when the new recruiting disposition is the qualified disposition. The recruiting system further includes a local computing system located remotely from the server. The local computing system includes the interface module. The interface module includes an input/output device that a recruiter uses to enter the applicant characteristics.

In further features, the local computing system provides the applicant characteristics to the server and receives the recruiting disposition from the server. The interface module includes a web browser. The server provides a web interface that receives the applicant characteristics from the web browser and provides the recruiting disposition to the interface module. The server stores the applicant characteristics and performs the comparisons between the applicant characteristics and the applicant guidelines.

In still other features, the local computing system includes a local repository that stores the applicant characteristics and the applicant guidelines. The applicant guidelines are received from the server; and a comparison module that performs the comparisons between the applicant characteristics and the applicant guidelines. The local computing system transmits the applicant characteristics to the server. The administration module includes a web browser. The server provides a web interface for updating the applicant guidelines. The applicant enters the applicant characteristics into the interface module.

A method includes storing applicant guidelines; receiving characteristics of an applicant; comparing the applicant characteristics to the applicant guidelines to generate a recruiting disposition for the applicant; storing the applicant characteristics when the recruiting disposition is other than a qualified disposition; selectively updating the applicant guidelines; and repeating the comparison between the applicant characteristics and the applicant guidelines to generate a new recruiting disposition when the applicant guidelines are updated. The applicant guidelines include physiological and educational guidelines. The applicant characteristics include physiological and educational characteristics.

In other features, the applicant guidelines include standards for military enlistment. The method further includes displaying the recruiting disposition. The method further includes providing the new recruiting disposition to a recruiter when the new recruiting disposition is the qualified disposition. The method further includes providing stored documents based on the recruiting disposition. The method further includes storing an image of the applicant. The method further includes analyzing the image to determine one of the applicant characteristics.

Further areas of applicability of the present disclosure will become apparent from the detailed description provided hereinafter. It should be understood that the detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIGS. 1A and 1B are flowcharts depicting steps performed by headquarters and a recruiter, respectively, in a recruiting process according to the prior art;

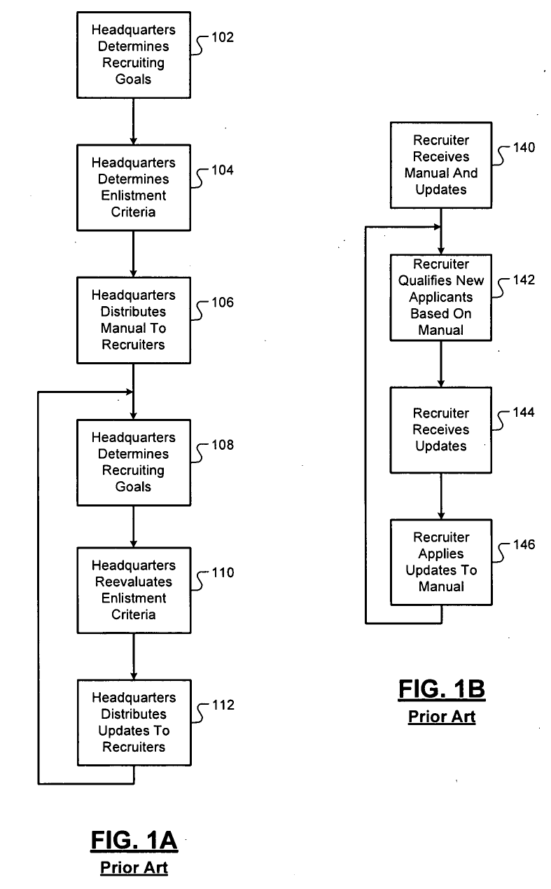

FIGS. 2A and 2B are functional block diagrams of exemplary implementations of a recruiting system according to the principles of the present disclosure according to the principles of the present disclosure;

FIG. 3 is a flowchart depicting exemplary overview steps performed by the recruiting system according to the principles of the present disclosure;

FIG. 4 is a flowchart depicting exemplary steps performed by an administrator in determining and implementing enlistment standards and subsequent changes to these standards according to the principles of the present disclosure;

FIG. 5 is a flowchart depicting exemplary steps performed in receiving standards updates and applying updates to previously screened applicants according to the principles of the present disclosure; and

FIG. 6 is a flowchart depicting exemplary steps performed in beginning an applicant qualification process, including determining applicant's prior service or employment status according to the principles of the present disclosure.

### DETAILED DESCRIPTION

The following description is merely exemplary in nature and is in no way intended to limit the disclosure, its application, or uses. For purposes of clarity, the same reference numbers will be used in the drawings to identify similar elements. As used herein, the phrase at least one of A, B, and C should be construed to mean a logical (A or B or C), using a non-exclusive logical or. It should be understood that steps within a method may be executed in different order without altering the principles of the present disclosure.

As used herein, the term module may refer to, be part of, or include an Application Specific Integrated Circuit (ASIC), an electronic circuit, a processor (shared, dedicated, or group) and/or memory (shared, dedicated, or group) that execute one or more software or firmware programs, a combinational logic circuit, and/or other suitable components that provide the described functionality.

The present disclosure describes a recruiting system, including software, which uses algorithms to determine recruiting dispositions (determinations of eligibility). The standards and criteria are set by a recruiting organization, which may include the United States Army Recruiting Command (USAREC), the Department of the Army, and/or any other division within the Army. In addition, the recruiting organization may include the Navy, the Marine Corps, the Air Force, the Coast Guard, or any other military or non-military organization that uses rule-based recruiting or uses defined hiring standards. For example, the recruiting organization may include a military organization of a country outside of the United States, such as Canada.

The standards and criteria determined by the recruiting organization can be organized into objective guidelines. These guidelines can be saved into the recruiting system, which may then be used as rules to determine dispositions on enlistment eligibility. For example, the standards and criteria may be derived from a document, such as AR 601-210 (used by the Army), or any other source of regulation. Guidelines may include algorithms, formulas, lists, litmus tests, flowcharts, weighted factors, etc.

A recruiter may enter an applicant's background history and personal information into the recruiting system, which then provides a determination of whether the applicant is qualified. The term recruiter refers both to recruiting staff that physically interfaces with recruits and to recruiting staff that uses, administers, or controls any part of the recruiting system.

In various implementations, an online interface is provided, where applicant information is entered through an online interface and a disposition is provided to the recruiter through the online interface. The online interface may include a hypertext markup language (html) interface, also known as a web interface. Beyond text and graphics, the online interface may include any suitable online technologies, such as Java, Javascript, Asynchronous JavaScript and extensible markup language (AJAX), PHP, Perl, Flash, and Silverlight. The online interface may be provided over a local area network, a proprietary wide area network, and/or a public distributed communications system, such as the Internet. Alternatively, applicant information may be sent to a remote host, which then returns a disposition to the local program.

In various implementations, a local copy of guidelines may be downloaded to the recruiter's computer. Such a local copy may be used to determine a disposition when network access is not available. In various implementations, a local program may be executed, which periodically retrieves eligibility criteria from a remote host. Information may be transmitted between the local program and the remote host using a web-based technology, such as Simple Object Access Protocol (SOAP), which relies on extensible markup language (XML).

Administrators within the recruiting organization may be able to modify the guidelines to meet their specific enlistment requirements. Once the guidelines are modified, they may instantly be made available, or may be made available at a later time or on a periodic schedule. A user interface may walk the recruiter through each step of the qualification process to determine an applicant's disposition from the recruiting organization guidelines. The user interface may be configured so that skipping a step is disallowed.

Once an applicant's information has been entered, the information may be stored for future use. If the applicant was not qualified at the time of entry, their information may be reevaluated after recruiting guidelines have been changed. In addition, some applicants may become qualified in the future even without changes to the recruiting guidelines. For example only, if an applicant is not qualified because a misdemeanor conviction was too recent, they may become qualified with the passage of time. Using the system of the present disclosure allows previously unqualified applicants to be recruited later, increasing the recruiter's efficiency and the overall number of recruits eligible for enlistment. In prior art systems, with no automatic process for reevaluating candidates, the recruiter would simply have to remember individual applicants' characteristics in view of possible criteria changes.

The length of time that an applicant's information is stored may be limited by privacy policies, and may be based on recruiting needs. For example, if recruiting needs are low when compared with the number of qualified applicants, reevaluating applicants may not be necessary—information may then be removed more quickly. In addition, the applicant may specify that they want to be notified of changes in their eligibility, and may specify the amount of time that the information should be retained.

The recruiting organization may modify guidelines for the entire organization or for individual entities. For example only, guidelines can be made specific to each geographical region and/or to each brigade or battalion. For example, the recruiting organization may also customize guidelines for specific parts of the world based on current and forecasted demands for new recruits.

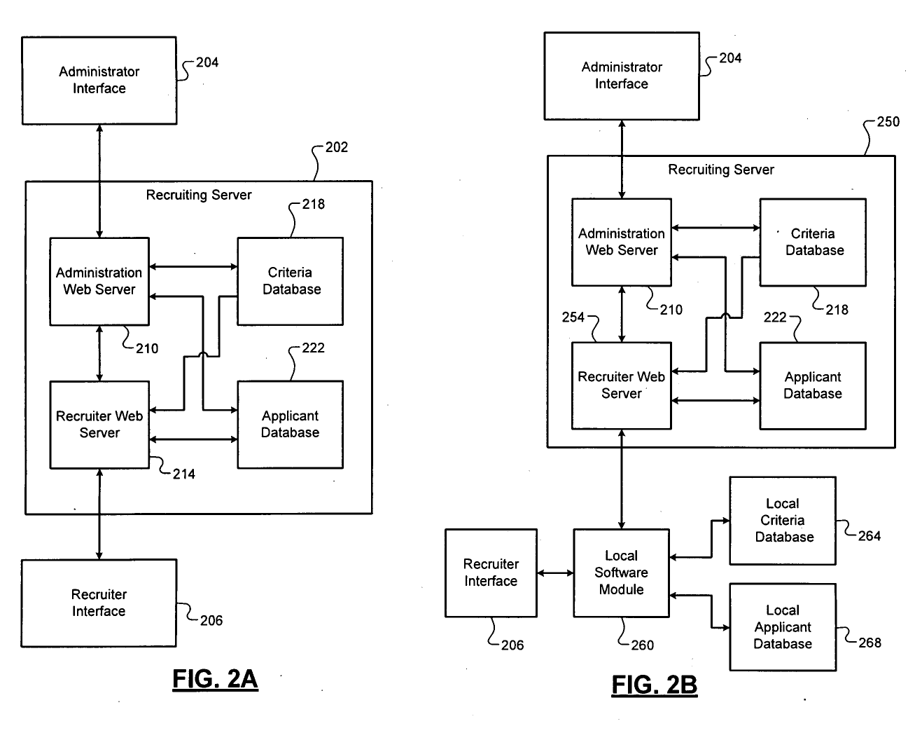

Referring now to FIG. 2A, a recruiting server 202 is accessed by an administrator interface 204 and a recruiter interface 206. The recruiting server 202 includes an administration web server 210, a recruiter web server 214, a criteria database 218, and an applicant database 222. The criteria database 218 stores recruiting criteria, including dispositions and which qualifications will result in which disposition.

The administrator interface 204 can update the criteria in the criteria database 218 via the administration web server 210. The administrator interface 204 may include a personal computer, web terminal, or any other suitable device. The administrator interface 204 may be used by the recruiting headquarters and may include authentication and multiple user rights profiles. The criteria database 218 may store current criteria and past criteria.

Changes to criteria may be disseminated to recruiters in text format so that all recruiting personnel may read what changes have been made to the system during the latest download. The system may also be configured so that other information (such as news, etc) may be disseminated as well. The system may also be configured to display all changes made so that recruiting personnel may reference changes to criteria.

The recruiter web server 214 receives applicant information from the recruiter interface 206. The recruiter interface 206 may include a personal computer, a web terminal, or any other suitable interface. The recruiter web server 214 and the recruiter interface 206 may perform authentication and may perform logging of any change that a user of the recruiter interface 206 makes. The recruiter may provide applicant data to the recruiter web server 214 via the recruiter interface 206.

The applicant data is stored into the applicant database 222. The applicant database 222 may retain applicant information even if the applicant is not qualified. When the administration web server 210 updates the criteria database 218, the administration web server 210 may indicate this change to the recruiter web server 214. The recruiter web server 214 uses criteria from the criteria database 218 to evaluate each applicant added to the applicant database 222. When the criteria changes, the recruiter web server 214 may reevaluate previously unqualified applicants from the applicant database 222. If any applicants are qualified by changes in the criteria database 218, the recruiter web server 214 may indicate this to the recruiter interface 206 when the appropriate user has logged in.

The recruiter web server 214 may communicate with multiple recruiter interfaces, including the recruiter interface 206. Likewise, the administration web server 210 may communicate with multiple administrator interfaces, including the administrator interface 204. The administration web server 210 may allow only a predetermined number of users to be connected to the administrator interface 204 at a single time. Alternatively, the administration web server 210 may maintain coherency of the criteria and other data between multiple administrator interfaces.

Administrators can access the applicant database 222 via the administration web server 210 to determine which applicants are qualified and to obtain recruiting data, metrics, and analytics. These data, metrics, and analytics may provide information such as background information and or qualifications of those who may be interested in joining the organization.

Using the information of applicants who have already applied, the organization is able to ascertain attributes of people who may be interested in joining the organization. For example only, this information may allow the organization to, among other functions, alter enlistment standards to best fit their recruiting goals by considering the personal profiles of those seeking to join.

This information may be stored, sorted, organized, reported, or utilized by various characteristics including (but not limited to): date interviewed, disposition results, applicant type, job interests, physical fitness, moral history, medical condition, number of dependants, education level, age, gender, geographical region, etc. For example only, these metrics and analytics may be converted into reports portraying a profile of those interested in joining the organization.

These reports may then be distributed to various levels of management for reference, usage, or review. These various levels of management may choose to use the informational reports as a tool to alter recruitment criteria and or recruiting tactics or techniques. The system may be used to provide different levels of system access to different users. For example only, users that may include administration, management, headquarters, or recruiters may each have different system access and or a user interface.

Additionally, in the event of a military draft, any military organization may choose to utilize this system to determine applicant eligibility for entry to that organization as well eligibility for specific jobs within that organization. An organization may use recruiting standards set by administrators employing this system to make these determinations. An organization may use these standards for enlistment/hiring, as well as the reports generated from the hiring process, to determine what types of applicants/enlistees/employees the organization may choose to lay off or retain in the event that the organization needs to lay off personnel or seeks to retain personnel for future employment. In addition, the recruiter web server 214 may store, such as in the applicant database 222, information regarding which criteria are proving to be the most exclusive when qualifying applicants.

Referring now to FIG. 2B, an exemplary implementation of a system including an offline recruiter interface is shown. A recruiting server 250 includes the criteria database 218, the applicant database 222, and the administration web server 210. The recruiting server 250 also includes a recruiting web server 254.

A local software module 260 communicates with the recruiter web server 254. The link between the recruiter web server 254 and the local software module 260 may be established over a distributed communications system, such as the internet, a local area network, and/or a proprietary wide area network. The local software module 260 retrieves, via the recruiter's web server 254, criteria from the criteria database 218 and applicant data from the applicant database 222.

Criteria data is stored in a local criteria database 264, while applicant data is stored in a local applicant database 268. In various implementations, the applicant data may be stored locally and not uploaded to any server. The applicant data is then used to aid the recruiter in determining a disposition, which can be reported to the recruiting organization.

In various implementations, criteria data stored in the local criteria database 264 may not be received directly via a web service. Instead, entire sets of criteria data and/or updates of criteria data may be distributed to recruiters and/or recruiting offices individually. For example, criteria data may be distributed via email or portable media, such as compact discs.

The recruiter interface 206 communicates with the local software module 260. For example, the recruiter interface 206 and the local software module 260 may reside on the same computer, which may be a laptop computer. Alternatively, the local software module 260 may reside on a recruiting office server, while the recruiter interface 206 resides on an individual workstation. Criteria data and applicant data may be encrypted during transmission and/or storage. Access to the recruiter interface 206 and the local software module 260 may require authentication, which may use schemes such as passwords and/or biometric identification. Access to any portion of the recruiting system may require authentication and in various implementations, all data transmission is encrypted.

By having local criteria and applicant data, the link between the local software module 260 and the recruiter web server 254 may be disconnected while still performing applicant qualification. In various implementations, the local criteria database 264 may be omitted, and a disposition will not be determined for an applicant until applicant information is uploaded to the recruiter web server 254.

Criteria may be downloaded to the local criteria database 264 at predetermined intervals. In addition, the local software module 260 may download new criteria when the version of criteria indicated by the recruiter web server 254 is newer than the local version of the criteria. Criteria information may include an expiration date, after which the criteria data is no longer considered valid. The system may be configured to prevent a disposition from being issued until recent criteria updates have been downloaded.

Applicant data stored in the local applicant database 268 that was received from the applicant database 222 may be read-only, or may be indicated as checked out/in use/unavailable by the applicant database 222. Data that is checked out by one person may be locked against editing by any other person. When new applicant data is uploaded from the local applicant database 268 to the applicant database 222, the data may then be marked as read-only in the local applicant database 268. In various implementations, the local applicant database 268 may store only data entered at the recruiter interface 206, and not data entered at any other recruiter interfaces.

In various implementations, the local applicant database 268 may store only applicant data corresponding to recruiters that are authorized to use the local software module 260. For example, if the local software module 260 is located in a recruiting office, applicant data may be stored only for applicants associated with recruiters stationed in that office. For example, applicants may be associated with a recruiter if they initially made contact with that recruiter or if they are being processed by that recruiter.

The recruiter interface 206 may receive applicant data in a web-based form. The web-based form may be adapted based on answers to questions. For example, those questions which the applicant's previous responses indicate are inapplicable may be hidden. Any answer that would disqualify the applicant under the current criteria or any possible future criteria may halt the process.

After entering applicant data, the recruiter interface 206 may display an applicant's disposition. In addition, the recruiter interface 206 may identify and/or provide documentation that may be required for enlistment eligibility and may generate a list of steps to be taken by the applicant and/or recruiter. These results may be displayed in electronic form and/or may be printed. The applicant database 222 may store information relating to when and if these requirements are completed.

In various implementations, an applicant interface may be implemented. For example, an applicant may access the recruiter web server 214 or another suitable web server associated with the recruiting server 202 over the Internet. The applicant may enter the same information that the recruiter would gather from the applicant. The applicant may receive an acknowledgement that the data was received.

The applicant may receive information, such as their tentative disposition and expected organizational job placement, based on their supplied information. Alternatively, the applicant may only receive a statement thanking them for supplying their information for recruiting purposes. In various implementations, the tentative disposition may be withheld if the disposition is a negative disposition to avoid discouraging the applicant from visiting a recruiter.

If the applicant receives a positive disposition, the applicant may be referred to a recruiter. The recruiter may also be notified about the applicant and may receive the information supplied by the applicant. The recruiter may then follow up with the applicant. The recruiter may verify the applicant's information in order to confirm their tentative disposition.

If the applicant's disposition is not positive, the applicant interface may suggest the steps the applicant could follow to reach a positive disposition. For example, as described below, suggestions may include completing an educational stage and losing weight. Even though suggestions are given, a recruiter may still follow up with the applicant to establish a recruiting relationship.

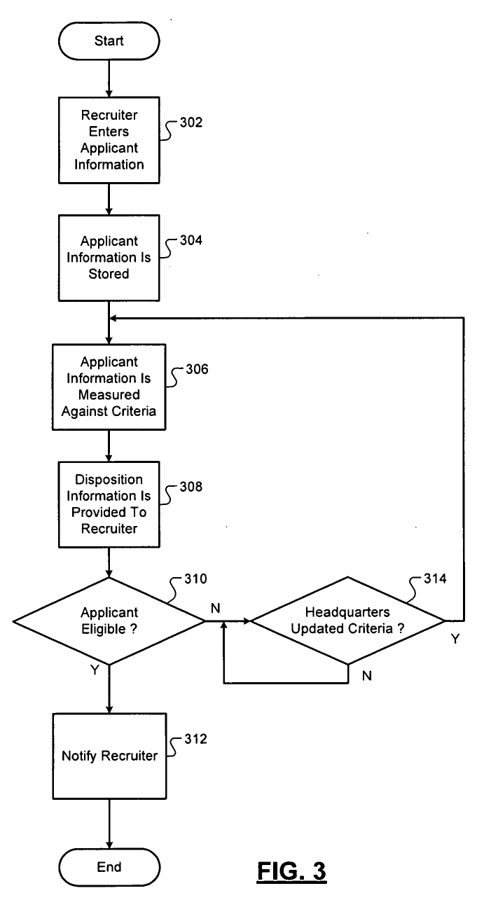

Referring now to FIG. 3, a flowchart depicts exemplary steps performed when processing a single applicant. Control begins in step 302 where the recruiter enters applicant information. Control continues in step 304 where the applicant's information is stored. Control continues in step 306 where applicant information is measured against current criteria. Control continues in step 308 where disposition of applicant status is provided to the recruiter. For example, this may include an indication if the applicant is eligible, not eligible, and/or that additional steps must be performed to establish eligibility.

Control continues in step 310 where control chooses the next step based on whether the applicant is eligible. If the applicant is eligible, control transfers to step 312; otherwise, control transfers to step 314. Applicant eligibility in step 310 may be determined based upon the disposition and whether any additional required steps, such as obtaining a waiver, have been completed successfully. In step 312, control notifies the recruiter of the newly qualified applicant. In addition, management and/or administrators may be notified. Control then ends with respect to that applicant. In step 314, control determines whether headquarters has updated the criteria. If so, control returns to step 306 to determine if the applicant is now qualified; otherwise, control remains in step 314.

Applicants may be processed based on moral criteria, education level, height/weight, number of dependants, age, etc. Depending on the applicant, the system may prompt the recruiter for other information, including waiver requirements and information about an applicant's prior service or employment. For example, prior service members may be evaluated based on re-entry code, separation code (description of previous discharge), grade determination (possible rank upon re-entry), etc. Unique applicants with special skills or situations may be evaluated using specialized guidelines. Unique applicants may include Arabic language translators, potential pilots, officer candidates, legal residents, and others.

To determine if an applicant is qualified, various evaluation schemes may be used. For example only, two such schemes will be described. In the first, each category will result in an individual disposition, such as qualified, requires review, requires waiver, or not qualified. For example, the applicant may be qualified with regard to criminal history, while their age requires waiver. The applicant's overall disposition may be determined by the most restrictive individual disposition.

For example only, if any of the individual dispositions is not qualified, the overall disposition is not qualified. If none of the individual dispositions are not qualified, but one of them requires waiver, the overall disposition is requires waiver. Similarly, if none of the individual dispositions are not qualified or require waiver, but one requires review, the overall disposition is requires review.

The second exemplary evaluation scheme involves a mathematical analysis. Each of the individual dispositions may be assigned a predetermined number of points. The applicant may be able to receive up to that number of points. If the applicant is deficient in a category, fewer points may be assigned, including zero or negative points. The applicant's overall disposition may be determined by combining the individual point values. For example, the points may be summed, and the total compared to a threshold. By exceeding one threshold, the applicant may be qualified. If only exceeding a second lower threshold, the applicant's disposition may require review or waiver.

The two evaluation schemes may be combined. For example, a point value may be assigned for each individual disposition. In addition, if an individual disposition determines that the applicant is unqualified or requires waiver or review, that disposition may control the overall disposition. If no individual disposition determines that the applicant is unqualified or requires waiver or review, the points from the individual dispositions can be used to determine the overall disposition.

For each individual disposition, schemes similar to the above may be used. In addition, another scheme, such as a logical decision tree, may be used. In addition, logical decision trees are applicable to the overall disposition and not just individual dispositions. A logical decision tree for criminal history may include the number of misdemeanor and felony charges and convictions. The recruiter may enter each charge along with the result of that charge (results may include: convicted, dropped, dismissed, or reduced). The recruiting system can then apply a logical tree to the answers.

For example only, if the applicant has more than two misdemeanor charges, the applicant may or may not be qualified. If the applicant has two misdemeanor charges and more than two misdemeanor convictions, the applicant is unqualified. If the applicant has two misdemeanor charges and one misdemeanor conviction, the applicant's disposition requires waiver. With two misdemeanor charges and no misdemeanor convictions, the applicant is qualified with respect to criminal history.

In a further specific example, the applicant may have been charged with “larceny under $500” as well as “altered drivers license.” The recruiting system may categorize both of these as misdemeanor charges. If the applicant has further been convicted of both charges, their record would indicate two misdemeanor charges and two misdemeanor convictions. This applicant's disposition may then require a waiver.

A mathematical method may be used, where elements of an applicant's criminal history may be categorized and scored. Categories may include minor traffic, minor non traffic, misdemeanor, and felony, and may be categorized differently based on whether charges were dropped or a conviction was made. In addition, the categories may be defined differently than their normal legal meaning. For example, a drug offense may be placed in a higher category. The number of points for various elements may be adjusted based on whether they represent recurring offenses.

For example, “larceny under $500” and “altered drivers license” may be categorized as misdemeanor charges, which may each have a point value of one. Each misdemeanor conviction may have a point value of four. The individual points may be summed to reach a point total of ten. The point total of ten may result in a waiver being required.

A logical decision tree can be applied across all criteria categories. For example, education may be evaluated first. At each branch, if a disposition is not reached, the branch may lead to another category, such as criminal history. In various implementations, multiple branches may lead to the same entry point of the next category.

In various implementations, an exhaustive list of dispositions for criteria combinations may be stored. For example, each possible combination may have a disposition associated with it. When the applicable combination is found, the associated disposition is used for the applicant. In various implementations, combinations that are not present in the list may be assumed to be unqualified.

For example, combinations may include NPS (non prior service), HS (high school) Diploma/Grad, One Felony Charge; NPS, HS Diploma/Grad, One Felony Charge, One Felony Conviction; NPS, HS Diploma/Grad, Two Felony Charges; PS (prior service), HS Diploma/Grad, Two Felony Charges; PS, HS Diploma/Grad, One Felony Charge, One Felony Conviction; PS, HS Diploma/Grad, Two Felony Charges, One Felony Conviction; etc.

Recruiting criteria may be defined separately for different types of applicants. For example, applicants may be divided into two categories. The first category may include applicants with no prior service or prior employment. The second category may include applicants with prior service or employment. Within each of these categories there may be multiple sub categories regarding areas that may include: education level, citizenship, specific job candidacy and more. Each of these categories may entail different criteria, different standards, and a different order of processing applicant information.

A recruiter's interaction with a software interface of the current system may involve logging in to a web-based or local program. The recruiter may select an applicant type from the main screen. The recruiter may be able to select from among two applicant types. In one example, the recruiter may select the first applicant type (Non-Prior Service).

The recruiter may then select civil and criminal violations that the applicant has been charged with, but not necessarily convicted of. Each charge in the list may be assigned a value. This value may be hidden from the recruiter to avoid tempting the recruiter to re-characterize the charge. For instance, the value for impeding traffic may be classified as an MT (Minor Traffic offense). The recruiter may then select any other applicable charges.

The recruiter may then select a user control, such as clicking a button, to indicate that identification of charges is complete. The system may then allow the recruiter to identify the result of each charge. For example, the first charge, “Impeding Traffic,” may have been dismissed. For example, for three misdemeanors and one felony, the results may be as follows: one misdemeanor dropped, one misdemeanor paid with a fine less than $500, one misdemeanor paid with a fine more than $500, and one felony dismissed. This may be evaluated by the system to see whether the applicant is qualified with regard to their criminal record.

The system may present the information entered in a confirmation screen for the recruiter to review the correctness of the information. This may happen after each step and/or for each category or grouping of criteria (such as health or criminal categories). If the applicant is determined to be unqualified after any step, the system may identify this to the recruiter. The recruiter may still gather the remaining data so that the applicant may later be qualified if the criteria change.

The system may then allow the recruiter to select or input medical information. The recruiter may select from a list any present or past health condition of the applicant. Certain conditions (past or present) may be immediate disqualifiers while others may require that further action be taken, such as obtaining medical records. Other conditions may require further testing and/or deferral of an applicant's admittance until a predetermined period of time has passed or an existing ailment has been satisfactorily treated, or a medial waiver or medical review has taken place.

The recruiter may then qualify the applicant based on their age. In various implementations, there may be various age limits, including: minimum age, maximum age, and maximum age for applicants having prior service or employment. The recruiter may enter the applicant's date of birth in order for the system to determine the applicant's age. The system may then compare their age to age limits.

For example only, if the applicant's age is less than 17, the applicant may be unqualified. If their age is 17 or over and less than 18, the applicant may be qualified with parental approval. For example only, if their age is over 18 but less than 42, then the applicant may be qualified as to age. If the applicant's age is over 42 then the applicant may be disqualified.

The system may now gather physiological characteristics, such as height, weight, and body fat percentage. In various implementations, this step may be reached only if no previous step has disqualified the applicant. However, in the interest of obtaining applicant information in anticipation of future criteria changes, all information gathering steps may be performed. In various implementations, the recruiter may be able to bypass the physiological characteristic qualification (or any other step in qualification) by indicating that the applicant is clearly within the recruiting standards. The system may be altered by management to allow or disallow the skipping of one or more steps.

Limits for each of the physiological characteristics may vary by age, gender, whether or not the applicant has had prior service or employment with the organization, and or other criteria. The recruiter may therefore enter the gender of the applicant (such as male or female) and the applicant's height (such as in inches or meters). The recruiter may also enter other measurements used in determining other physiological characteristics, such as body fat percentage. For example, the recruiter may enter weight, a waist measurement, and a neck measurement. The system may then calculate a body fat percentage.

The system may compare the physiological characteristics of the applicant to limits based on the applicant's age, gender, prior service and or employment with the organization. In various implementations, the limits may be based on more or fewer factors. If the body fat percentage is over the allowable limit but under a predetermined percentage, such as 30%, the system may notify the recruiter that the applicant is eligible for a physical fitness test. The physical fitness test may include a stair-step exercise, where applicants may be considered physically qualified if their heart rate stays below a predetermined level. The system may also recommend another physiological standard or test to determine applicant suitability in regards to physical fitness or any other category of enlistment.

The recruiter may then qualify the applicant based on their education level. In various implementations, the applicant's education level may be selected from a list. The recruiter may then qualify the applicant based on the number of dependants they have. The number of dependants that an applicant may have may be based on the rank that the applicant will have upon enlistment. The system may determine the applicant's enlistment rank or the recruiter may specify the rank. The system may then determine an upper limit and use the limit to qualify the applicant with regards to number of dependants.

After entering applicant information, continuously, and/or at various points in the qualification process, a summary of the applicant's qualification status may be displayed. Each category of qualification may be summarized with a disposition as to that category, which may be displayed graphically. For example only, a green check mark may indicate qualified, a yellow circle may indicate that a waiver or review is required, and a red x may indicate not qualified. In addition, the system may display which specific area the applicant is deficient in, if any, and may suggest possible remedies that may be used to enable qualification. For example only, the system may display how many pounds or waistline inches the applicant needs to lose to become qualified.

If the system determines that the applicant is not qualified, the system may explain why the applicant was not qualified. This gives the recruiter a chance to review the entered information to ensure that he or she did not enter incorrect information. The system may also offer possible solutions that may allow further documentation or actions to qualify the individual.

The system may track the number of applicants that the recruiter enters into the system as well as the number of previously unqualified applicants that the system determines are qualified based on changes in enlistment criteria. This data may be used to evaluate the recruiter's performance and to verify that recruiters are following up on their leads. The system may also enable the recruiter to collect information on applicants who are interested in the organization, whether they are qualified or not. The system may analyze applicant and/or recruiter data by region.

When the system finds applicants who have become qualified due to enlistment criteria changes, the system may present those applicants to the recruiter who interacted with them. Each recruiter and/or various levels of supervision may get a list of applicants who have become qualified. In various implementations, the list may be sorted in order of preference in recruiting. For example only, the applicants may be sorted according to number of criminal charges.

The system may allow recruiters to continue interviewing applicants even though they are facially unqualified according to the current criteria. For example only, should the recruiting headquarters refuse candidates having a GED, the recruiter can still gather information from applicants who have a GED. If the recruiting headquarters changes this rule, the recruiters will have a ready pool of applicants upon which to draw.

The system may determine what waiver and/or review or waiting period is necessary (if any), and list the documents and procedures that the recruiter and applicant may need to follow to put the applicant in condition for recruitment. The system may determine the jobs an applicant may qualify for once recruited. This determination may be based on their moral, medical, dependant, and age information, among other criteria. For example only, the system may also display bonuses (either past, present, or future values) for which the applicant may be qualified.

Upon completion of the qualification process, the system may provide a printable list of the documents required for enlistment. The system may also provide a list of the procedures needed for enlistment. For example, the applicant may require a waiver, obtain a physical examination, and/or obtain medical, criminal, driving records, and or other information. Therefore, the program may standardize necessary documents and procedures for enlistment/hiring of each applicant and applicant type.

This standardization of requiring various documents and or procedures may be created by management and disseminated using a system of servers and interfaces. For example only, headquarters may require that all applicants have fingerprints prior to enlistment. Therefore, management may configure the program to include a requirement for fingerprinting of all applicants as part of the enlistment process.

This standardization of management's requirements of various documentation and or procedures may vary based on recruitment needs for certain types of applicants, and or by geographical region. For example only, headquarters may require that all applicants from a certain geographical region file additional documentation prior to enlistment. Therefore, management may configure the system to include a requirement for obtaining additional documentation for the applicants from this certain geographical region as part of the enlistment process.

The system may determine the pay-grade upon re-enlistment or re-hiring of an applicant with prior service or employment. This determination may depend on how much time has passed since the applicant's prior service or employment ended, which branch they were discharged from, what rank they were when they were discharged, their re-entry code, their separation code, and or other criteria.

The system may allow the information of high school juniors (Grade 11) to be entered. This may allow the recruiter to more easily recruit both from high school as well as reserve or National Guard services. This may allow for the system to keep track of said applicants and easily transfer/enlist them from one status into another. This may include transferring between student, reservist, active duty, or other categories.

The recruiting criteria may include restrictions on tattoos, body piercings, and other physical alterations, which may be described with words, pictures, and/or examples. The system may present up-to-date pictures and examples to the recruiter so that the recruiter can determine whether any disqualifying body alterations are present. The system may also allow pictures to be taken and/or uploaded so that physical alterations may be evaluated by supervisors and/or so that the body alterations may be evaluated against current or future criteria. The type, location, and wording of tattoos or other body alterations may also be entered to index the pictorial information.

In various implementations, the recruiter may use a computer, PDA or other device to collect data concerning the applicant's body modifications. For example only, the recruiter may take one or more pictures of the applicant. These pictures may be stored for future analysis. The pictures may be overlaid by example images of acceptable and unacceptable sizes and locations of body modifications, such as tattoos. These can be compared by the recruiter to determine the applicant's disposition with respect to body modifications. The pictures may be retained so they can be compared to future body modification guidelines. In addition, computerized analysis may be performed on the pictures, either in real time or offline.

Alternatively, the recruiter may be presented with a digital representation of a human body that can be annotated to indicate what body modifications have been performed. Locations and sizes can be recorded, written descriptions can be included, and pictures can be attached.

The system may determine restrictions and waiver requirements for driving under the influence (DUI) charges. Limits may be based on the charge, the conviction, the total number of charges or convictions, the time between charges or convictions, and the time since the most recent occurrence, among other criteria. Similar limits may also be assessed for other substance abuse crimes, including, but not limited to possession of marijuana. When evaluating criminal records, the system may recognize equivalent charges and/or convictions that have different names in different jurisdictions.

The recruiter may be able to jump directly to a specific part of the evaluation. In various implementations, the recruiter may do this when a particular area may be in question. For example, when an applicant has many dependants, the recruiter may perform this evaluation first. However, the recruiter may still capture the applicant's other information where the dependant criteria are changed.

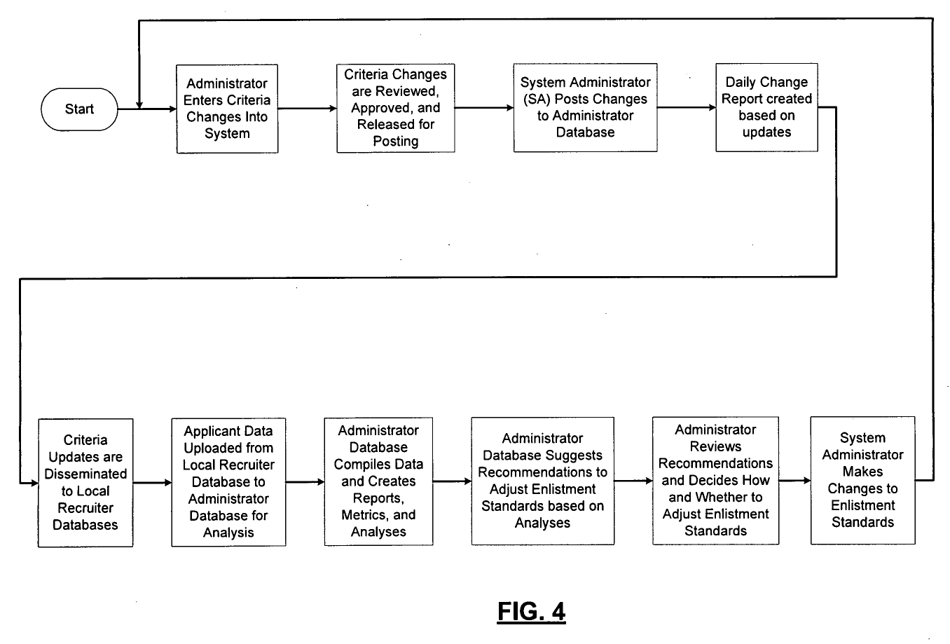

Referring now to FIG. 4, additional considerations for the depicted steps are as follows: the recruiter may access the recruiting system by logging into the program locally on their own device, or remotely from another device through a secure network, server, internet site, and/or some other medium. The administrator may update enlistment criteria and disseminate information to recruiters on a schedule or as needed.

A confirmation screen may appear after successfully downloading criteria updates, which may ensure that updates to recruiting criteria are accurate, current, and complete. In addition, the administrator may receive a confirmation screen after updating the recruiting criteria. This confirmation screen may require a supervisor's credentials. There may be restricted access to the recruiting system. For example only, access may be protected by ID cards, PIN numbers, biometric identification, and/or passwords.

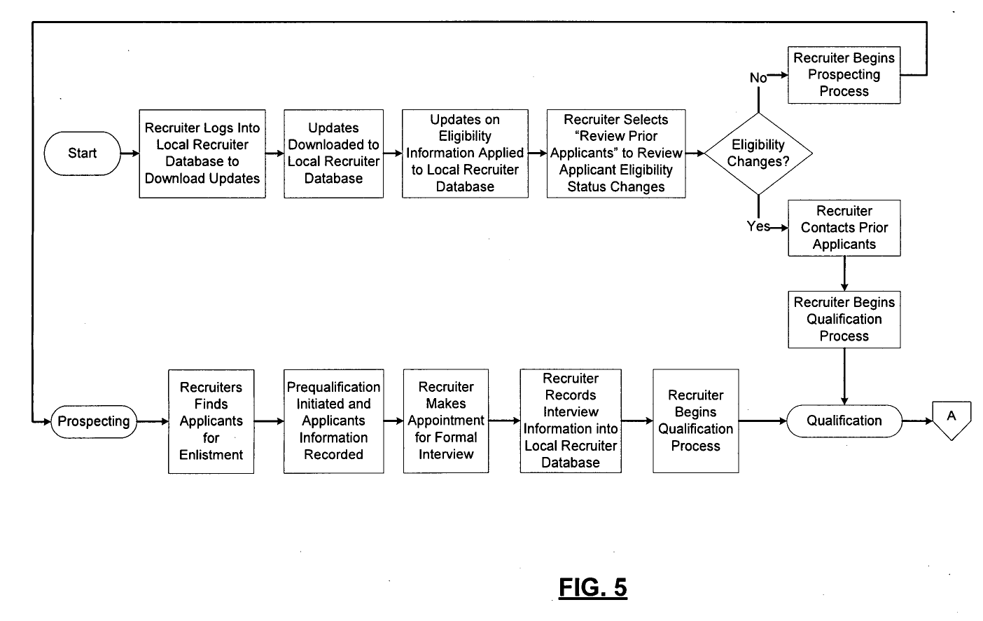

Referring now to FIG. 5, additional considerations for the depicted steps are as follows: the system may include a process which will ensure that the recruiter downloads updates to enlistment criteria. This process may ensure that updates to enlistment criteria are accurate, current, and complete. In addition to this, the system may have the ability to restrict access in the system to qualified individuals. Also, the system may notify recruiters, supervisors, or any other entities concerning newly qualified applicants (previously disqualified) to ensure that they are identified and contacted.

The recruiter may be able to review any prior applicants who have been qualified based on new eligibility changes. For example only, the recruiter may click a button labeled “Review Prior Applicants.” In various implementations, the system may download new enlistment criteria automatically, such as at scheduled intervals. Alternatively or additionally, the system may notify the local program that updates are available, at which point they can be downloaded.

Depicted steps that are shown in FIG. 5 also include a process that may allow administrators to update enlistment criteria and disseminate this information to recruiters as scheduled or as needed. Access to this information may be restricted to authorized individuals. Once all enlistment changes are downloaded, a confirmation screen may appear to notify the user that all updates have been downloaded successfully. After the updates are downloaded, the system may reevaluate previous applicants using the latest enlistment criteria. The system may prevent a final disposition from being issued until the most recent updates have been downloaded.

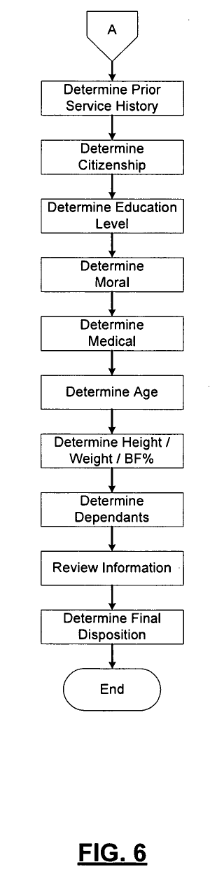

Referring now to FIG. 6, additional considerations for the depicted steps are as follows. After logging into recruiting system and initiating a new applicant's profile, the recruiter may select whether the applicant has prior service or employment with the organization. For example only, a non-prior-service applicant will be discussed. The recruiter may be constrained to complete the categories listed in the process diagram. The order of the categories may vary by applicant type. After completing each enlistment category for the applicant, the recruiting system may provide a disposition for that category.

The recruiting system may present the recruiter with a list of citizenship status possibilities for entry. The recruiter may select one citizenship status from the list provided that fits the applicant's situation. The recruiting system may then present the recruiter with a citizenship status disposition. This entry/input may record information about the applicant's citizenship. For example only, the following citizenship choices may be presented: natural born U.S. citizen, foreign national, legal resident, Canadian-born Native American, and other.

A citizenship disposition may then be made. The system may also display what actions are necessary to streamline the enrollment process for an applicant that requires a waiver or review. The system may provide the recruiter with options that may be utilized to enable an applicant to be qualified. Examples may include increasing education level, decreasing body fat percentage, etc. In the example concerning citizenship, the system may provide the recruiter with assistance that may include one or more of the following dispositions: qualified, not qualified, and obtain INS-551 card to fulfill citizenship qualification standards

The recruiting system may present the recruiter with a list of education level possibilities for entry. The recruiter may select an education level from the list provided that fits the applicant's situation. The recruiting system may present the recruiter with an education level disposition. This entry/input may record information about the applicant's education level. For example only, the following education level choices may be presented: High School Senior, High School Diploma, GED, GED+15 College Semester Hours, College Graduate, and Other. The system may provide one or more of the following dispositions: qualified, not qualified, and qualified when enrolled for GED to fulfill education qualification standards.

The recruiting system may present a recruiter with a list of moral/criminal charge possibilities for entry. The recruiter may select the moral/criminal charges that fit the applicant's situation. The recruiting system may then prompt the recruiter to select a result of each charge. In various implementations, the system may accept free-form input, and may include natural language processing. This entry/input may record information about the applicant's moral/criminal history. For example only, the following moral/criminal history choices may be presented: Minor Non-Traffic, Minor Traffic, Misdemeanor, Felony, and Other. The result of each charge choices may be presented: Convicted, Reduced, Dismissed, Dropped, or Other.

In addition, the system may receive jurisdiction information for the applicant. The system may then present the recruiter with a moral/criminal disposition. In various implementations, the jurisdiction information may aid the system in identifying other criminal records for the applicant. The system may verify the applicant's criminal history and may identify other criminal record information that was withheld. In various implementations, the system may interface with criminal records databases of various jurisdictions. The system may also display what actions are necessary to streamline the enrollment process for an applicant that requires a waiver or review.

The recruiting system may present a recruiter with a list of medical history possibilities for entry. The recruiter may select the medical history possibilities from the list provided that fits the applicant's situation. The recruiting system may present the recruiter with a medical history disposition. In addition, the system may accept free form text and perform keyword recognition. This entry/input may record information about the applicant's medical history. For example only, the following medical history choices may be presented: Wheezing or Inhaler, Dislocated Joint, Epilepsy, Asthma, etc.

A medical history disposition may then be made. The system may also display what actions are necessary to streamline the enrollment process for an applicant that requires a waiver or review. The system may also offer options for qualifying a candidate who is currently not qualified. The system may provide the recruiter with assistance that may include one or more of the following dispositions: Qualified, Requires Medical Waiver, Requires Medical Review, and Not Qualified to fulfill medical qualification standards.

The recruiting system may present the recruiter with a date prompt for date-of-birth entry. For applicants having prior service or employment with the organization, the recruiting system may prompt the recruiter to record the total number of months the applicant has spent in any branch of the organization or a related organization. For example, a military applicant may be required to disclose the number or months spent with any branch of the military whether active or reserve. The recruiting system may then present the recruiter with an age requirements disposition.

An age requirements disposition may then be made. The system may provide the recruiter with assistance that may include one or more of the following dispositions: Qualified, Not Qualified, Requires Waiver, Requires and Requires Parental Consent to fulfill medical qualification standards.

The recruiting system may present the recruiter with height, weight, neck, waist, or other measurement prompts. Alternately, the recruiter may select the input/enter measurements into the list provided that fits the applicant's situation. The recruiting system may present the recruiter with a fitness disposition for the applicant. In addition, the system may accept free form text and perform keyword recognition. This entry/input may record information about the applicant's fitness. For example only, the following measurement inputs/entries may be presented: Height in Feet in Inches, Weight in Lbs., Neck Measurement in Inches, and Waist Measurement in Inches.

A fitness disposition may then be made. The system may recommend that the applicant decrease waste size by a specific number of inches, weight by a specific number of pounds, etc. The system may provide the recruiter with assistance that may include one or more of the following dispositions: Qualified, Not Qualified, Requires Waiver, or Requires Second Level Measurement.

The recruiting system may present the recruiter with a prompt to enter information concerning the number of dependants that the applicant has. It also may prompt the recruiter to enter into the program certain personal qualifications, which may be used to determine the rank the applicant may have upon entry. In addition, the system may accept free form text and perform keyword recognition. Using this information, the system may determine the maximum number of dependants that an applicant my have upon entry. The system may then present the recruiter with a disposition with regard to dependants.

The system may provide the recruiter with options that can be utilized to enable the applicant to be qualified. Examples may include obtaining waiver, or completing documents necessary to release custody, etc. In the example concerning dependants, the system may provide the recruiter with assistance that may include one or more of the following dispositions: Qualified, Not Qualified, or Qualified with Waiver Approval to fulfill the dependant number qualification standards.

The recruiting system may present the recruiter with a final disposition. The final disposition may account for all entries made in each category by the recruiter for the applicant. The final disposition may provide a summary of each category completed, and the individual disposition of each of those categories completed during the applicant Interview. The system may also offer options for qualifying a candidate who is currently not qualified.

For example only, the system may provide the recruiter with options that can be used to enable the applicant to be qualified. Examples may include obtaining waiver or review, or completing documents necessary to become qualified, etc. The system may provide the recruiter with assistance that may include one or more of the following dispositions: Qualified, Qualified with Waiver, Qualified with Review, Documents Required for Enlistment, Procedures Required for Enlistment, or Disqualified.

After presenting the final disposition, the recruiting system may present the recruiter with a list of job possibilities for the applicant. For example only, in a military environment, the system may provide the recruiter with assistance that may include one or more of the following jobs: Infantry, Armor Crew Member, Combat Engineer, Combat Medic, etc. It may also display signing bonuses (including present, past, or expected future values) for each of the jobs highlighted.

The system may verify that applicant information is accurate and complete. For example, data may be checked against public records and/or government and/or private databases. Also, the system may ensure that all qualification procedures are defined and that all applicant information is collected and recorded accurately or completely. For example only, the system may print and/or display information to the applicant for verification of its correctness and completeness. The recruiting system may not allow an applicant's final disposition to be issued until enlistment criteria are fully completed by the recruiter. The recruiting system may validate all applicant interview information against the most current enlistment criteria.

The recruiting system may track the time, date, and geographical location of each recruiter interaction with a potential applicant. This tracking may be performed with global positioning system (GPS) technology, which may be included in a mobile phone or mobile computer typically carried by a recruiter.

Collecting this data may allow the system to identify geographical regions that are producing the most recruits as well as geographical locations that have not been prospected adequately. The recruiter may take a picture of the area where the contact was made as well as take a picture of the applicant. These pictures may be geotagged with location, time, and date information and used to supplement the recruiter's memory. The recruiter may also record other information of use to future recruiting efforts.

Users of the recruiting system may use a variety of input mechanisms including voice recognition, touchscreens, stylus-operated tablets, etc. when interacting with the recruiting system. The recruiting system may also provide data in a variety of forms, which may include computer speech, such as text-to-speech conversion. These techniques may increase recruiter and administration efficiency and may expand the ability of those with disabilities to participate in the recruiting system.

Those skilled in the art can now appreciate from the foregoing description that the broad teachings of the disclosure can be implemented in a variety of forms. Therefore, while this disclosure includes particular examples, the true scope of the disclosure should not be so limited since other modifications will become apparent to the skilled practitioner upon a study of the drawings, the specification, and the following claims.

What is claimed is:

1. A recruiting system comprising:
a server that stores applicant guidelines, wherein the applicant guidelines include physiological and educational guidelines;
an administration module that selectively updates the applicant guidelines in the server; and
an interface module that receives characteristics of an applicant, wherein the applicant characteristics include physiological and educational characteristics, wherein the applicant characteristics are compared to the applicant guidelines to generate a recruiting disposition for the applicant, wherein the applicant characteristics are stored when the recruiting disposition is other than a qualified disposition, and wherein the comparison between the applicant characteristics and the applicant guidelines is repeated to generate a new recruiting disposition when the administration module updates the applicant guidelines.

2. The recruiting system of claim 1 wherein the applicant guidelines include standards for military enlistment.

3. The recruiting system of claim 1 wherein the interface module displays the recruiting disposition.

4. The recruiting system of claim 1 wherein the interface module displays the new recruiting disposition when the new recruiting disposition is the qualified disposition.

5. The recruiting system of claim 1 further comprising a local computing system located remotely from the server, wherein the local computing system includes the interface module.

6. The recruiting system of claim 5 wherein the interface module includes an input/output device that a recruiter uses to enter the applicant characteristics.

7. The recruiting system of claim 5 wherein the local computing system provides the applicant characteristics to the server and receives the recruiting disposition from the server.

8. The recruiting system of claim 7 wherein the interface module comprises a web browser, wherein the server provides a web interface that receives the applicant characteristics from the web browser and provides the recruiting disposition to the interface module.

9. The recruiting system of claim 7 wherein the server stores the applicant characteristics and performs the comparisons between the applicant characteristics and the applicant guidelines.

10. The recruiting system of claim 5 wherein the local computing system includes:
a local repository that stores the applicant characteristics and the applicant guidelines, wherein the applicant guidelines are received from the server; and
a comparison module that performs the comparisons between the applicant characteristics and the applicant guidelines.

11. The recruiting system of claim 10 wherein the local computing system transmits the applicant characteristics to the server.

12. The recruiting system of claim 1 wherein the administration module comprises a web browser, and wherein the server provides a web interface for updating the applicant guidelines.

13. The recruiting system of claim 1 wherein the applicant enters the applicant characteristics into the interface module.

14. A method comprising:
storing applicant guidelines, wherein the applicant guidelines include physiological and educational guidelines;
receiving characteristics of an applicant, wherein the applicant characteristics include physiological and educational characteristics;
comparing the applicant characteristics to the applicant guidelines to generate a recruiting disposition for the applicant;
storing the applicant characteristics when the recruiting disposition is other than a qualified disposition;
selectively updating the applicant guidelines; and
repeating the comparison between the applicant characteristics and the applicant guidelines to generate a new recruiting disposition when the applicant guidelines are updated.

15. The method of claim 14 wherein the applicant guidelines include standards for military enlistment.

16. The method of claim 14 further comprising displaying the recruiting disposition.

17. The method of claim 14 further comprising providing the new recruiting disposition to a recruiter when the new recruiting disposition is the qualified disposition.

18. The method of claim 14 further comprising providing stored documents based on the recruiting disposition.

19. The method of claim 14 further comprising storing an image of the applicant.

20. The method of claim 19 further comprising analyzing the image to determine one of the applicant characteristics.
